(19) United States
(12) Patent Application Publication
(10) Pub. No.: US 2025/0308050 A1
(43) Pub. Date: Oct. 2, 2025

(54) METHOD FOR INSPECTING SETTER AND METHOD FOR MANUFACTURING HONEYCOMB STRUCTURE

(71) Applicant: NGK INSULATORS, LTD., Nagoya-City (JP)

(72) Inventors: Daniel Yukichi KITAGUCHI, Inazawa-Shi (JP); Akinari FUKAYA, Nagoya-Shi (JP)

(73) Assignee: NGK INSULATORS, LTD., Nagoya-City (JP)

(21) Appl. No.: 19/071,942

(22) Filed: Mar. 6, 2025

(30) Foreign Application Priority Data
Mar. 29, 2024 (JP) 2024-058098

(51) Int. Cl. G06T 7/60; C04B 38/00; G06T 7/00

(52) U.S. Cl. CPC G06T 7/60; G06T 7/0004; C04B 38/0006

(57) ABSTRACT

A method for inspecting a setter, which is disposed between a shelf board and a honeycomb formed body when the honeycomb formed body is fired, the setter including a placement surface for placing the honeycomb formed body, the method includes: a step A1 of imaging the placement surface using a 3D scanner to obtain a first image of the placement surface, wherein each pixel constituting the first image has a coordinate information and a height information; and a step B1 of determining whether or not there is a local height abnormality on the placement surface based on the coordinate information and the height information of each pixel constituting the first image of the placement surface.

### CROSS REFERENCE TO RELATED APPLICATIONS

The present invention claims the benefit of priority to Japanese Patent Application No. 2024-58098 filed on Mar. 29, 2024 with the Japanese Patent Office, the entire contents of which are incorporated herein by reference in its entirety.

### FIELD OF THE INVENTION

The present invention relates to a method for inspecting a setter and a method for manufacturing a honeycomb structure.

### BACKGROUND OF THE INVENTION

Honeycomb structures are used as filters for collecting particulate matter in exhaust gas emitted from internal combustion engines such as diesel engines, and as carriers for catalysts for purifying toxic gas components such as CO, HC, and NOx.

In general, a honeycomb structure has an outer peripheral side wall and partition walls disposed on the inner peripheral side of the outer peripheral side wall, the partition walls partitioning a plurality of cells that form flow paths from a first end surface to a second end surface. A honeycomb structure can be manufactured by kneading a raw material composition obtained by appropriately adding various additives to a ceramic raw material, a pore-forming material, a binder, and a dispersion medium to form a green body, and then extrusion molding the green body through a die that defines a predetermined cell structure to produce a honeycomb formed body, and this honeycomb formed body is then cut to a predetermined length, dried, and then fired.

When carrying out the firing step, the honeycomb formed body is placed on a shelf board with one end surface facing downward, and is then loaded together with the shelf board into a firing furnace. At this time, in order to prevent the honeycomb formed body from adhering to the shelf board and to improve the quality of the end surface of the honeycomb structure after firing, a firing base plate called a “setter” is interposed between the shelf board and the honeycomb formed body to prevent the honeycomb formed body from coming into direct contact with the shelf board. For example, a setter made by molding and firing a ceramic material is known (Patent Literature 1 and 2).

### PRIOR ART

### Patent Literature

[Patent Literature 1] Japanese Patent Application Publication No. 2003-82403
[Patent Literature 2] Japanese Patent Application Publication No. 2016-98123

### SUMMARY OF THE INVENTION

The quality of the placement surface of the setter, which comes into contact with the end surface of the honeycomb formed body during the firing step, affects the quality of the honeycomb structure obtained after firing. For example, local unevenness on the surface on which the setter is placed prevents smooth firing shrinkage at the contact area with the setter, which may cause deformation or cracks in the partition walls at the end surface of the honeycomb structure. Furthermore, if there is a local dirt on the surface on which the setter is placed, there is a risk that the color will transfer to the end surface of the honeycomb structure, causing discoloration.

For this reason, the placement surface of the setter is required to be smooth so as not to interfere with the firing shrinkage of the honeycomb formed body, and to have a clean appearance. In particular, in recent years, honeycomb structures have become thinner in walls (making manufacturing more difficult), and defects such as cracks and deformations in the partition walls occur frequently during firing, so stricter quality control is required for the placement surface of the setter.

However, conventionally, inspection of the placement surface of the setter has been performed visually by humans, and there have been cases where abnormality in the placement surface of the setter has been unnoticed. In this case, there is a problem that the frequency of producing honeycomb structures that do not satisfy the quality standard increases, resulting in a decrease in yield. In addition, since the inspections performed by humans were sensory inspections, there was variation in judgment. Also, during the inspection, a height gauge was sometimes used to measure the height of local unevenness on the placement surface of the setter, causing a longer inspection time.

The present invention has been made in consideration of the above circumstances, and an object of one embodiment of the present invention is to provide a method for inspecting a setter that can be efficiently implemented and also helps to reduce variation in judgment. Further, an object of another embodiment of the present invention is to provide a method for manufacturing a honeycomb structure using such an inspection method.

As a result of intensive research conducted by the present inventors in order to solve the above problems, the present invention has been completed, and is exemplified as below.

### [Aspect 1]

A method for inspecting a setter, which is disposed between a shelf board and a honeycomb formed body when the honeycomb formed body is fired, the setter comprising a placement surface for placing the honeycomb formed body, the method comprising:
a step A1 of imaging the placement surface using a 3D scanner to obtain a first image of the placement surface, wherein each pixel constituting the first image has a coordinate information and a height information; and
a step B1 of determining whether or not there is a local height abnormality on the placement surface based on the coordinate information and the height information of each pixel constituting the first image of the placement surface.

### [Aspect 2]

The method according to aspect 1, wherein the step B1 is carried out based on whether or not a region satisfying a predetermined height abnormality condition is present and spreads so as to satisfy a predetermined size condition in the first image of the placement surface.

### [Aspect 3]

The method according to aspect 1 or 2, wherein the step B1 comprises calculating a difference or ratio between an average height calculated based on the height information possessed by all pixels constituting the first image of the placement surface and a height possessed by each pixel constituting the first image of the placement surface.

### [Aspect 4]

The method according to any one of aspects 1 to 3, wherein the first image is provided as a heat map in which the coordinate information and the height information are associated with each other.

### [Aspect 5]

The method according to any one of aspects 1 to 4, wherein an inspection device carries out the step A1 and the step B1, the inspection device comprising:
the 3D scanner;
a first image processing unit capable of carrying out the step B1 by image processing the first image obtained by the 3D scanner; and
an output unit capable of outputting a result of carrying out the step B1 by the first image processing unit.

### [Aspect 6]

The method according to aspect 5, wherein the inspection device is disposed at a position where the inspection device can inspect the setter on a conveyor,
wherein the inspection device comprises a robot capable of removing the setter from the conveyor and a transport controller capable of controlling the robot, and
when the inspection device performs the method for inspecting the setter on the conveyor and determines that there is the local height abnormality, the inspection device controls the robot to remove the setter from the conveyor.

### [Aspect 7]

A method for manufacturing a honeycomb structure, comprising:
a step of carrying out the inspection method according to any one of aspects 1 to 6;
a step of placing the setter that is determined to have no local height abnormality as a result of carrying out the inspection method on the shelf board;
a step of preparing a honeycomb formed body having an outer peripheral side wall and partition walls disposed on an inner peripheral side of the outer peripheral side wall, the partition walls partitioning a plurality of cells forming a flow path from a first end surface to a second end surface; and
a step of placing the honeycomb formed body on the setter on the shelf board such that the first end surface or the second end surface is in contact with the placement surface of the setter, and firing the honeycomb formed body.

### [Aspect 8]

A method for inspecting a setter, which is disposed between a shelf board and a honeycomb formed body when the honeycomb formed body is fired, the setter comprising a placement surface for placing the honeycomb formed body, the method comprising:
a step A2 of imaging the placement surface using a camera to obtain a second image of the placement surface, wherein each pixel constituting the second image has a coordinate information and a luminance information; and
a step C2 of determining whether or not there is a local dirt on the placement surface based on the coordinate information and the luminance information of each pixel constituting the second image of the placement surface.

### [Aspect 9]

The method according to aspect 8, wherein the step C2 is carried out based on whether or not a region satisfying a predetermined luminance abnormality condition is present and spreads so as to satisfy a predetermined size condition in the second image of the placement surface.

### [Aspect 10]

The method according to aspect 8 or 9, wherein the step C2 comprises calculating a difference or ratio between an average luminance calculated based on the luminance information possessed by all pixels constituting the second image of the placement surface and a luminance possessed by each pixel constituting the second image of the placement surface.

### [Aspect 11]

The method according to any one of aspects 8 to 10, wherein an inspection device carries out the step A2 and the step C2, the inspection device comprising:
the camera;
a second image processing unit capable of carrying out the step C2 by image processing the second image obtained by the camera; and
an output unit capable of outputting a result of carrying out the step C2 by the second image processing unit.

### [Aspect 12]

The method according to aspect 11, wherein the inspection device is disposed at a position where the inspection device can inspect the setter on a conveyor,
wherein the inspection device comprises a robot capable of removing the setter from the conveyor and a transport controller capable of controlling the robot, and
when the inspection device performs the method for inspecting the setter on the conveyor and determines that there is the local dirt, the inspection device controls the robot to remove the setter from the conveyor.

### [Aspect 13]

A method for manufacturing a honeycomb structure, comprising:
a step of carrying out the inspection method according to any one of aspects 8 to 12;
a step of placing the setter that is determined to have no local dirt as a result of carrying out the inspection method on the shelf board;
a step of preparing a honeycomb formed body having an outer peripheral side wall and partition walls disposed on an inner peripheral side of the outer peripheral side wall, the partition walls partitioning a plurality of cells forming a flow path from a first end surface to a second end surface; and
a step of placing the honeycomb formed body on the setter on the shelf board such that the first end surface or the second end surface is in contact with the placement surface of the setter, and firing the honeycomb formed body.

### [Aspect 14]

A method for inspecting a setter, which is disposed between a shelf board and a honeycomb formed body when the honeycomb formed body is fired, the setter comprising a placement surface for placing the honeycomb formed body, the method comprising:
a step A3 of imaging the placement surface using a camera-type 3D scanner to obtain a first image of the placement surface, wherein each pixel constituting the first image has a coordinate information and a height information, and a second image of the placement surface, wherein each pixel constituting the second image has a coordinate information and a luminance information;
a step B3 of determining whether or not there is a local height abnormality on the placement surface based on the coordinate information and the height information of each pixel constituting the first image of the placement surface; and
a step C3 of determining whether or not there is a local dirt on the placement surface based on the coordinate information and the luminance information of each pixel constituting the second image of the placement surface.

### [Aspect 15]

The method according to aspect 14, wherein the step B3 is carried out based on whether or not a region satisfying a predetermined height abnormality condition is present and spreads so as to satisfy a predetermined size condition in the first image of the placement surface.

### [Aspect 16]

The method according to aspect 14 or 15, wherein the step B3 comprises calculating a difference or ratio between an average height calculated based on the height information possessed by all pixels constituting the first image of the placement surface and a height possessed by each pixel constituting the first image of the placement surface.

### [Aspect 17]

The method according to any one of aspects 14 to 16, wherein the first image is provided as a heat map in which the coordinate information and the height information are associated with each other.

### [Aspect 18]

The method according to any one of aspects 14 to 17, wherein the step C3 is carried out based on whether or not a region satisfying a predetermined luminance abnormality condition is present and spreads so as to satisfy a predetermined size condition in the second image of the placement surface.

### [Aspect 19]

The method according to any one of aspects 14 to 18, wherein the step C3 comprises calculating a difference or ratio between an average luminance calculated based on the luminance information possessed by all pixels constituting the second image of the placement surface and a luminance possessed by each pixel constituting the second image of the placement surface.

### [Aspect 20]

The method according to any one of aspects 14 to 19, wherein an inspection device carries out the step A3, the step B3, and the step C3, the inspection device comprising:
the camera-type 3D scanner;
a first image processing unit capable of carrying out the step B3 by image processing the first image obtained by the camera-type 3D scanner;
a second image processing unit capable of carrying out the step C3 by image processing the second image obtained by the camera-type 3D scanner; and
an output unit capable of outputting a result of carrying out the step B3 by the first image processing unit and a result of carrying out the step C3 by the second image processing unit.

### [Aspect 21]

The method according to aspect 20, wherein the inspection device is disposed at a position where the inspection device can inspect the setter on a conveyor,
wherein the inspection device comprises a robot capable of removing the setter from the conveyor and a transport controller capable of controlling the robot, and
when the inspection device performs the method for inspecting the setter on the conveyor, and determines that there is the local height abnormality and/or determines that there is the local dirt, the inspection device controls the robot to remove the setter from the conveyor.

### [Aspect 22]

A method for manufacturing a honeycomb structure, comprising:
a step of carrying out the inspection method according to any one of aspects 14 to 21;
a step of placing the setter that is determined to have no height abnormality and have no local dirt as a result of carrying out the inspection method on the shelf board;
a step of preparing a honeycomb formed body having an outer peripheral side wall and partition walls disposed on an inner peripheral side of the outer peripheral side wall, the partition walls partitioning a plurality of cells forming a flow path from a first end surface to a second end surface; and
a step of placing the honeycomb formed body on the setter on the shelf board such that the first end surface or the second end surface is in contact with the placement surface of the setter, and firing the honeycomb formed body.

According to the method for inspecting a setter in one embodiment of the present invention, the information required for inspection can be obtained quickly by using a 3D scanner, a camera, or a camera-type 3D scanner, making it possible to carry out the inspection efficiently. In addition, according to the inspection method, since the inspection can be performed based on highly objective information, it is possible to perform the inspection of the setter with small variation in judgment. As a result, the inspection accuracy is improved, and the method inspecting a setter also contributes to improving the yield of honeycomb structures.

### BRIEF DESCRIPTION OF THE DRAWINGS

FIG. 1 is a perspective view showing a wall-through type honeycomb structure.

FIG. 2 is a schematic cross-sectional view of a wall-through type honeycomb structure when observed from a cross section parallel to the direction in which the cells extend.

FIG. 3 is a perspective view showing a wall-flow type pilar-shaped honeycomb structure.

FIG. 4 is a schematic cross-sectional view of a wall-flow type pilar-shaped honeycomb structure when observed from a cross section parallel to the direction in which the cells extend.

FIG. 5 is a schematic exploded perspective view for explaining the positional relationship of a honeycomb formed body, a setter, and a shelf board.

FIG. 6 is an example of a heat map of a placement surface of a setter imaged using a 3D scanner.

FIG. 7 is an example of an image having coordinate information and luminance information of a placement surface of a setter imaged using a camera.

FIG. 8A is a schematic side view for explaining the configuration of an inspection device according to a first embodiment of the present invention.

FIG. 8B is a schematic side view for explaining the configuration of an inspection device according to a second embodiment of the present invention.

FIG. 8C is a schematic side view for explaining the configuration of an inspection device according to a third embodiment of the present invention.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### <1. Honeycomb Structure>

A honeycomb structure according to one embodiment of the present invention has an outer peripheral side wall, and partition walls disposed on the inner peripheral side of the outer peripheral side wall, the partition walls partitioning a plurality of cells that form a flow path from a first end surface to a second end surface. The honeycomb structure is provided in one embodiment as a wall-through or wall-flow pillar-shaped honeycomb structure. The application of the honeycomb structure is not particularly limited, and may be used in various industrial applications, such as heat sinks, filters (for example, GPF, DPF), catalyst carriers, sliding parts, nozzles, heat exchangers, electrical insulating members, and parts for semiconductor manufacturing equipment. Among these, the honeycomb structure can be suitably used as a filter for collecting particulate matter contained in exhaust gas from an internal combustion engine, a boiler, or the like, and as a catalyst carrier for an exhaust gas purification catalyst. In particular, the honeycomb structure can be suitably used as an exhaust gas filter and/or a catalyst carrier for an automobile.

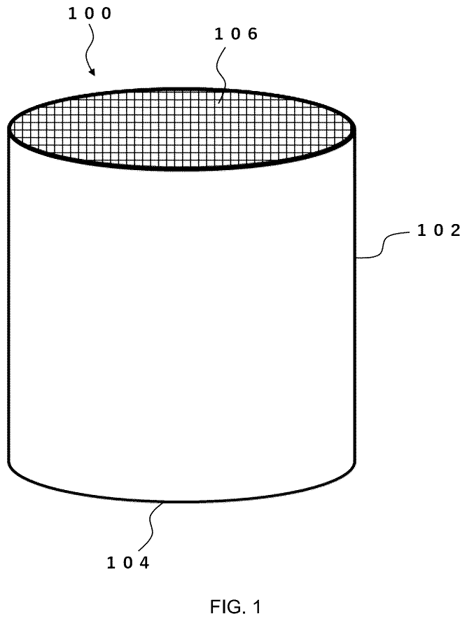

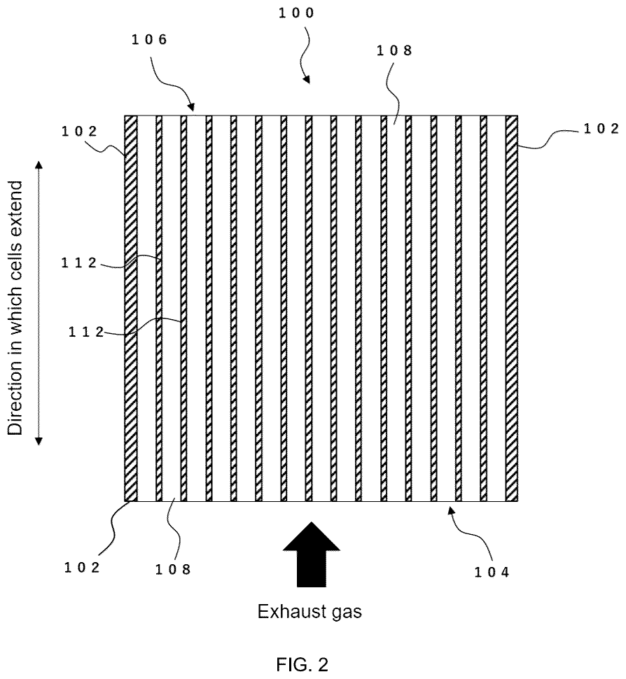

FIGS. 1 and 2 are a schematic perspective view and a cross-sectional view, respectively, of a wall-through type honeycomb structure 100. This honeycomb structure 100 comprises an outer peripheral side wall 102 and partition walls 112 arranged on the inner peripheral side of the outer peripheral side wall 102, the partition walls partitioning a plurality of parallel cells 108 that form flow paths from a first end surface 104 to a second end surface 106. In this honeycomb structure 100, both ends of each cell 108 are open, and exhaust gas that flows into one cell 108 from the first end surface 104 is purified while passing through the cell, and flows out from the second end surface 106. Here, the first end surface 104 is defined as the upstream side of the exhaust gas, and the second end surface 106 is defined as the downstream side of the exhaust gas. However, the distinction between the first end surface and the second end surface is for convenience, and the second end surface 106 may be defined as the upstream side of the exhaust gas, and the first end surface 104 may be defined as the downstream side of the exhaust gas.

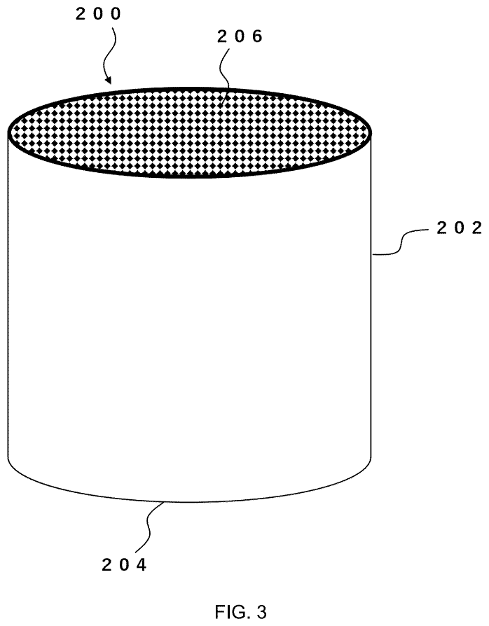

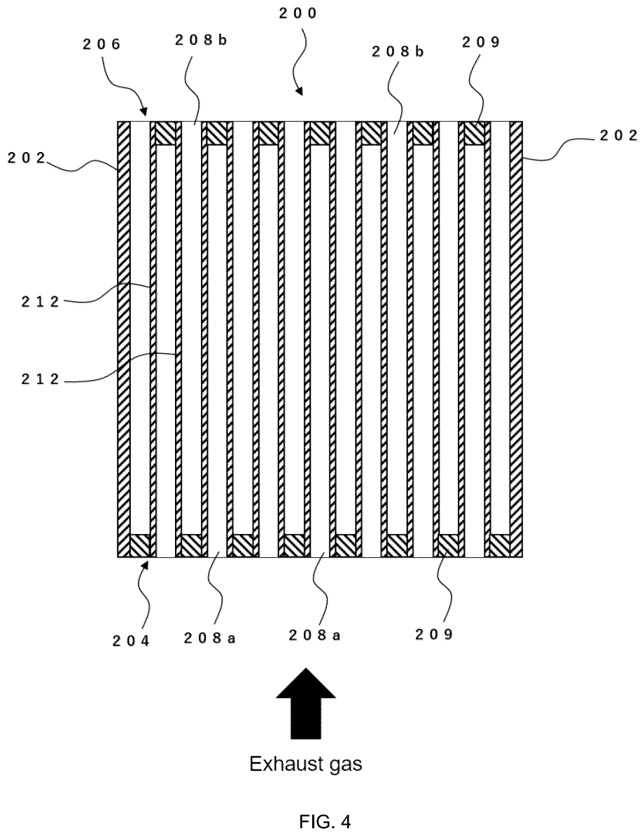

FIGS. 3 and 4 are a schematic perspective view and a cross-sectional view, respectively, of a wall-flow type honeycomb structure 200. This honeycomb structure 200 comprises an outer peripheral side wall 202 and partition walls 212 arranged on the inner peripheral side of the outer peripheral side wall 202 and defining a plurality of parallel cells 208a, 208b that form flow paths for a fluid from a first end surface 204 to a second end surface 206. In the honeycomb structure 200, the plurality of cells 208a, 208b can be divided into a plurality of first cells 208a disposed on the inner side the outer peripheral side wall 202, extending from the first end surface 204 to the second end surface 206, having openings on the first end surface 204 and sealing portions 209 on the second end surface 206, and a plurality of second cells 208b disposed inside the outer peripheral side wall 202, extending from the first end surface 204 to the second end surface 206, having sealing portions 209 on the first end surface 204 openings on the second end surface 206. Further, in this honeycomb structure 200, the first cells 208a and the second cells 208b are alternately arranged adjacent to each other with the partition walls 212 interposed therebetween.

When exhaust gas containing particulate matter such as soot is supplied to the first end surface 204 on the upstream side of the honeycomb structure 200, the exhaust gas is introduced into the first cells 208a and travels downstream within the first cells 208a. Since the first cells 208a have sealing portions 209 on the second end surface 206 on the downstream side, the exhaust gas passes through the partition walls 212 that separates the first cells 208a and the second cells 208b and flows into the second cells 208b. Since the particulate matter cannot pass through the partition walls 212, it is collected and deposited within the first cells 208a. After the particulate matter is removed, the clean exhaust gas that has flowed into the second cells 208b travels downstream within the second cells 208b and flows out from the second end surface 206 on the downstream side. Here, the first end surface 204 is defined as the upstream side of the exhaust gas, and the second end surface 206 is defined as the downstream side of the exhaust gas, but the distinction between the first end surface and the second end surface is for convenience, and the second end surface 206 may be defined as the upstream side of the exhaust gas, and the first end surface 204 may be defined as the downstream side of the exhaust gas.

The shape of the end surfaces of honeycomb structure is not limited, and may be, for example, a round shape such as a circle, an ellipse, a racetrack shape, or a long circle shape, a polygonal shape such as a triangle or a quadrangle, or other irregular shape. The honeycomb structure shown in the figure has a circular shape of the end surfaces and is cylindrical as a whole.

Although there is no limitation on the shape of the cells in a cross section perpendicular to the flow direction of the cells, a quadrangle, a hexagon, an octagon, or a combination of these is preferable. Among these, a square and a hexagon are preferable. By using such a cell shape, it is possible to reduce the pressure loss when a fluid is caused to flow through the pillar-shaped honeycomb structure.

The height of the honeycomb structure (the length from the first end surface to the second end surface) is not particularly limited and may be appropriately set depending on the application and required performance. The height of the honeycomb structure may be, for example, 40 mm to 450 mm, typically 44 mm to 170 mm. There is also no particular limitation on the relationship between the height of the honeycomb structure and the maximum diameter of each end surface (which refers to the maximum length among the diameters passing through the center of gravity of each end surface of the honeycomb structure). Therefore, the height of the honeycomb structure may be longer than the maximum diameter of each end surface, or the height of the honeycomb structure may be shorter than the maximum diameter of each end surface. For example, the maximum diameter of each end surface of the honeycomb structure may be 50 to 400 mm, typically 76 to 185 mm.

The cell density of the honeycomb structure (the number of cells per unit cross-sectional area perpendicular to the cell extension direction) is not particularly limited, but may be, for example, 6 to 2000 cells/inch² (0.9 to 310 cells/cm²), preferably 50 to 1500 cells/inch² (7.8 to 232.5 cells/cm²), and particularly preferably 300 to 1200 cells/inch² (46.5 to 186 cells/cm²). Here, the cell density is calculated by dividing the total number of cells on one end surface of the honeycomb structure excluding the peripheral side wall (if any sealed cells are present, the calculation is performed assuming that the cells are not sealed) by the end surface area of the end surface.

The thickness of the partition walls in the honeycomb structure is preferably 210 μm or less, more preferably 150 μm or less, and even more preferably 100 μm or less, from the viewpoint of reducing pressure loss and heat capacity by making the walls thinner. Further, from the viewpoint of ensuring strength, the thickness of the partition walls in the honeycomb structure is preferably 50 μm or more, more preferably 60 μm or more, and further preferably 70 μm or more. The thickness of the partition wall refers to a crossing length of a line segment that crosses the partition wall when the centers of gravity of adjacent cells are connected by this line segment in a cross-section orthogonal to the direction in which the cells extend (height direction of the honeycomb structure).

The porosity of the partition walls is preferably 45% or more, and more preferably 50% or more, from the viewpoint of suppressing pressure loss and reducing heat capacity by increasing the porosity. In addition, the upper limit of the porosity of the partition walls is preferably 60% or less, and more preferably 55% or less, from the viewpoint of ensuring the strength of the honeycomb structure. Therefore, the porosity of the partition walls is, for example, preferably 45 to 60%, and more preferably 50 to 55%. The porosity is measured by mercury porosimetry method using a mercury porosimeter. The mercury porosimetry method is specified in JIS R1655: 2003. As used herein, a partition wall sample of a honeycomb structure (a cube of length×width×height=about 13 mm×about 13 mm×about 13 mm) is taken from two locations, one is near the center in the radial direction at the center in the height direction and the other is near the outer periphery at the center in the height direction, and the porosity is measured by the mercury porosimetry method, and the average value is taken as the measured value.

The material constituting the partition walls and the outer peripheral side walls of the honeycomb structure is not limited, but may be porous ceramics. Types of ceramics include cordierite, mullite, zirconium phosphate, aluminum titanate, silicon carbide (SiC), silicon-silicon carbide composites (for example, Si-bonded SiC), cordierite-silicon carbide composites, zirconia, spinel, indialite, sapphirine, corundum, titania, silicon nitride, and the like. Further, for these ceramics, one type may be contained alone, or two or more types may be contained in combination.

When the honeycomb structure is used as a catalyst carrier, the surface of the partition walls can be coated with a catalyst according to the purpose. As the catalyst, one type may be used alone, or two or more types may be used in combination. As the catalyst, although not limited, mention can be made to a diesel oxidation catalyst (DOC) for oxidizing and burning hydrocarbons (HC) and carbon monoxide (CO) to increase exhaust gas temperature, a PM combustion catalyst that assists in the combustion of PM such as soot, an SCR catalyst and an NSR catalyst that remove nitrogen oxides (NOx), as well as a three-way catalyst that can simultaneously remove hydrocarbons (HC), carbon monoxide (CO), and nitrogen oxides (NOx). The catalyst may contain as appropriate, for example, noble metals (Pt, Pd, Rh, and the like), alkali metals (Li, Na, K, Cs, and the like), alkaline earth metals (Mg, Ca, Ba, Sr, and the like.), rare earths (Ce, Sm, Gd, Nd, Y, La, Pr, and the like), transition metals (Mn, Fe, Co, Ni, Cu, Zn, Sc, Ti, Zr, V, Cr, and the like), and the like.

To manufacture the above-mentioned honeycomb structure, first, a raw material composition containing a ceramic raw material, a dispersion medium, a pore-forming material and a binder is kneaded to form a green body, and then the green body is extrusion molded to form the desired honeycomb formed body. After drying the honeycomb formed body, sealing portions are formed on both end surfaces of the honeycomb formed body as necessary, and the sealing portions are dried. Next, the honeycomb formed body is degreased and fired, whereby a honeycomb structure can be manufactured.

### <2. Setter>

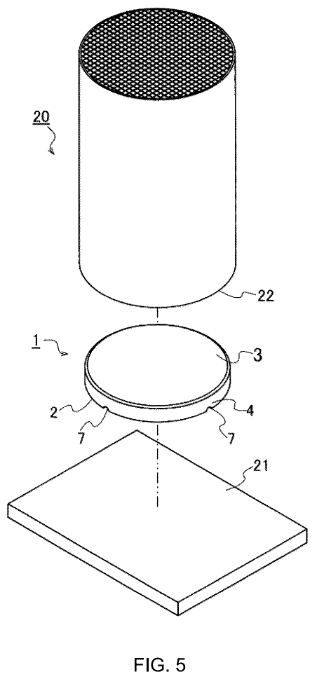

When firing the honeycomb formed body, a setter is interposed between the shelf board and the honeycomb formed body. FIG. 5 shows an exploded perspective view that shows a schematic view of the setter 1 being placed on the shelf board 21 and the honeycomb formed body 20 being placed on the setter 1 on the shelf board 21 such that the first end surface or the second end surface 22 is in contact with the placement surface 3 of the setter 1.

The setter can be provided, for example, as a porous disc-shaped member formed from a ceramic material. The setter 1 has a lower surface 2 located on the lower side, which is the surface facing the shelf board 21, a placement surface 3 located on the upper side the setter1, which faces opposite to the lower surface 2 and is in at least partial contact with the end surface 22 of the honeycomb formed body 20, and a side surface 4 that connects the outer edges of the lower surface 2 and the placement surface 3. The lower surface 2 of the setter1 may be provided with a plurality of grooves 7 extending radially and linearly from the center of the lower surface 2. When the grooves 7 are provided, it is possible to prevent a plurality of setter1 from sticking to each other when stacked for storage or the like.

The material of the setter1 is not particularly limited, and for example, various materials that have been conventionally used as a base material for setter for firing can be used. For example, it is possible to use a material that converts into a mullite material, a cordierite material, a silicon carbide material, an alumina material, or the like by firing at a high temperature.

The method for forming the setter1 is not particularly limited. For example, a press mold formed according to the shape of the setter can be used, the raw ceramic material can be filled into the mold, and a desired pressure can be applied to form the setter. After applying the pressure, a setter formed body is removed from the mold and fired to produce the setter. This allows mass production of ceramic setters.

### <3. Method for Inspecting Setter>

According to one embodiment of the present invention, there is provided a method for inspecting a setter interposed between a shelf board and a honeycomb formed body when the honeycomb formed body is fired. Hereinafter, a first embodiment using a 3D scanner, a second embodiment using a camera, and a third embodiment using a camera-type 3D scanner will be described.

### 3-1. First Embodiment

The method for inspecting a setter according to the first embodiment comprises:
a step A1 of imaging the placement surface of the setter using a 3D scanner to obtain a first image of the placement surface, wherein each pixel constituting the first image has a coordinate information and a height information; and
a step B1 of determining whether or not there is a local height abnormality on the placement surface based on the coordinate information and the height information of each pixel constituting the first image of the placement surface.

In the step A1, the placement surface of the setter, which is the subject of inspection, is imaged using a 3D scanner to obtain a first image of the placement surface, wherein each pixel constituting the first image has a coordinate information and a height information. A 3D scanner is hardware that can measure the three-dimensional shape of an object and capture it as point cloud data. The 3D scanner is preferably a non-contact 3D scanner. Examples of the non-contact 3D scanner include a laser beam type and a grid pattern light projection type (or a pattern projection type). In order to improve the inspection accuracy, the 3D scanner preferably has a pixel resolution of 100 μm/pix or less in the planar directions (X direction, Y direction) and a pixel resolution of 10 μm/1 luminance value or less in the height direction (Z direction). For example, a scanner having a pixel resolution of 50 to 80 μm/pix in the planar directions (X direction, Y direction) and a pixel resolution of 3 to 7 μm/1 luminance value in the height direction (Z direction) can be used. The point cloud data can be converted into mesh data by software provided with the 3D scanner, and an image (first image) having the coordinate information and the height information corresponding to the placement surface of the setter can be obtained. When converting the point cloud data into mesh data, various processes such as smoothing, filling, and bridging may be performed.

In addition, when capturing an image using a 3D scanner, noise may occur due to the projection of the grid pattern light. Therefore, in order to remove noise, it is preferable to remove noise by taking the difference in height information for each pixel between an image obtained by imaging a jig (master jig) that mimics a normal placement surface of the setter with a 3D scanner and the first image. The difference may be regarded as height information for each pixel in the first image. In addition, when imaging the placement surface of the setter, it is desirable to image the placement surface of the setter from a direction as perpendicular as possible to the placement surface of the setter. Furthermore, in order to deal with cases where the imaging direction is tilted, it is preferable to calculate the surface tilt based on height information for each pixel in the first image and perform processing to make the tilt zero by tilt correction.

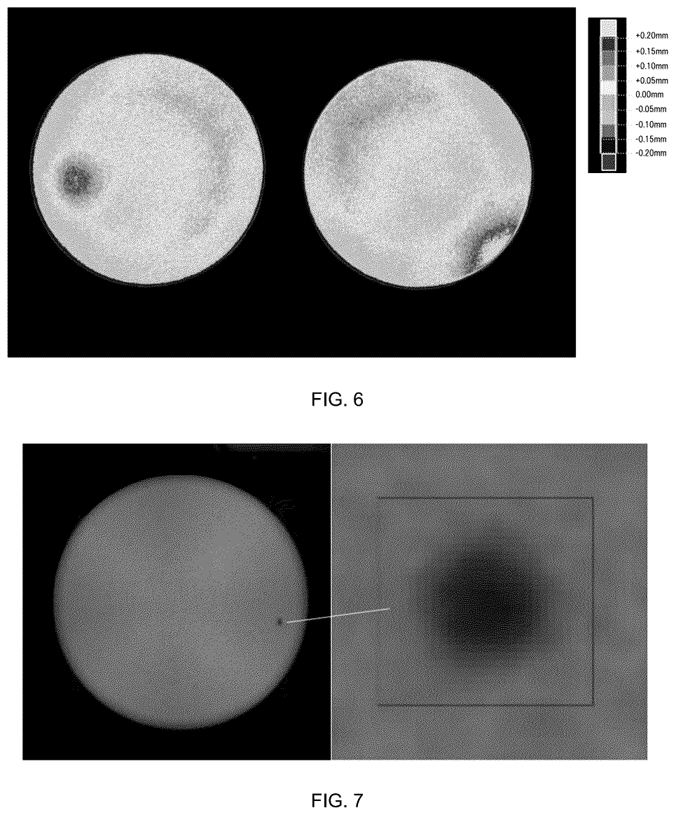

By using a 3D scanner, it is possible to obtain images containing objective information about the height of each local region (each pixel on the image) that constitutes the placement surface of the setter, making inspections more efficient. The first image can be provided, for example, as a heat map in which coordinate information and height information are associated (see FIG. 6). In the heat map, height differences are displayed by color, making it easy to visually identify local height abnormality. In the left image, a locally high height region is visible on the left side of the placement surface of the setter. In the right image, a locally high height region is visible on the bottom right of the setter.

In the step B1, the presence or absence of a local height abnormality on the placement surface is determined based on the height information and coordinate information of each pixel constituting the first image of the placement surface. This decision can be made by a human or by software based on predetermined criteria. The coordinate information of each pixel constituting the first image of the placement surface is information about the position of the pixel in the first image in a planar direction. Here, the coordinate information may be expressed as a set of numbers for specifying the position of a pixel in the first image, or may be expressed by the position of a pixel in the first image. In addition, the height information of each pixel constituting the first image on the placement surface is information about a position in a direction perpendicular to the plane.

The criteria for determining whether or not there is a local height abnormality on the placement surface can be set by collecting, for a large number of setters, the coordinate information and the height information of the placement surface of the setters, and a data set regarding the presence or absence of abnormality in the honeycomb structure manufactured using the setters, and deriving the causal relationship between these two. As a method for determining whether or not there is an abnormality in a honeycomb structure, for example, if at least one of deformation of the partition wall and cracks in the partition wall are found on the end surface of the honeycomb structure that was in contact with the setter during firing, it is determined to be abnormal, and if neither is found, it is determined to be normal.

The criteria for determining whether or not there is a local height abnormality on the placement surface are set in consideration of the following (a) to (d).
(a) Minimize the percentage of cases where the setter was judged to have no abnormality but the honeycomb structure had an abnormality (setter OK/honeycomb NG).
(b) Minimize the percentage of cases where the setter was judged to have an abnormality but the honeycomb structure had no abnormality (setter NG/honeycomb OK).
(c) Maximize the percentage of cases where the setter was judged to have no abnormality and the honeycomb structure also had no abnormality (setter OK/honeycomb OK).
(d) Maximize the percentage of cases where the setter was judged to have an abnormality and the honeycomb structure also had an abnormality (setter NG/honeycomb NG).

Among these, the highest priority is given to reducing the percentage of setter OK/honeycomb NG.

The criteria are preferably set such that the percentage of setter OK/honeycomb NG is, for example, 0.1% or less, and more preferably 0.02% or less, with respect to the number of the setters inspected. Furthermore, the criteria are preferably set such that the percentage of setter NG/honeycomb OK is 0.1% or less, and more preferably 0.03% or less, with respect to the number of the setters inspected. However, since whether or not abnormality occurs in the honeycomb structure is not only due to the abnormality in the setter, it is difficult to reduce the percentage to completely 0%.

Furthermore, the criteria are preferably set such that the percentage of setter OK/honeycomb OK is, for example, 99.90% or more, and more preferably 99.95% or more, with respect to the number of the setters inspected. Furthermore, the criteria are preferably set such that the percentage of setter NG/honeycomb NG is 99.90% or more, and more preferably 99.94% or more, with respect to the number of the setters inspected. However, since whether or not abnormality occurs in the honeycomb structure is not only due to the abnormality in the setter, it is difficult to increase the percentage to 100%.

The causal relationship between these two may be learned by machine learning using the coordinate information and the height information of the placement surface of the setter, and the presence or absence of abnormality in the honeycomb structure manufactured using the setter, as training data. Prediction accuracy is improved if all honeycomb formed bodies to be fired for machine learning are those that are to be given the same product number (that is, honeycomb formed bodies with the same design specifications). Inspection accuracy is improved if all honeycomb formed bodies to be fired for machine learning are those that are intended to be given the same product number (that is, honeycomb formed bodies with the same design specifications). For the machine learning, known learning models such as a neural network, a support vector machine, or the like. Deep learning may be used when training the neural network.

In one embodiment, the step B1 is carried out based on whether or not a region satisfying a predetermined height abnormality condition is present in the first image and extends so as to satisfy a predetermined size condition of the placement surface. The predetermined condition for abnormal height may be, for example, a condition regarding a difference or a ratio with respect to the average height of the placement surface. The predetermined size condition may be a condition regarding the area or diameter (equivalent circle diameter or the like) of a continuous region that satisfies a condition regarding the difference or ratio with respect to the average height of the placement surface. According to the inventor's experiments, for example, it is possible to obtain high inspection accuracy by determining that a local height abnormality exists on the placement surface when there is one or more continuous regions that are higher by more than X mm (selected from 0.1≤X≤0.2) relative to the average height of the placement surface and with an area of Y mm² (selected from 0.2≤Y≤0.3) or more, it can be determined that a local height abnormality exists on the placement surface. In addition, it is possible to obtain even higher inspection accuracy by also determining that a local height abnormality exists on the placement surface when the total area of dispersed regions that are higher by more than X mm (selected from 0.1≤X≤0.2) relative to the average height of the placement surface of the setter is Z mm² or more (selected from 0.1≤Z≤1.0). Therefore, in one embodiment, the step B1 comprises calculating the difference or ratio between an average height calculated based on height information possessed by all pixels constituting the first image of the placement surface and the height possessed by each pixel constituting the first image of the placement surface.

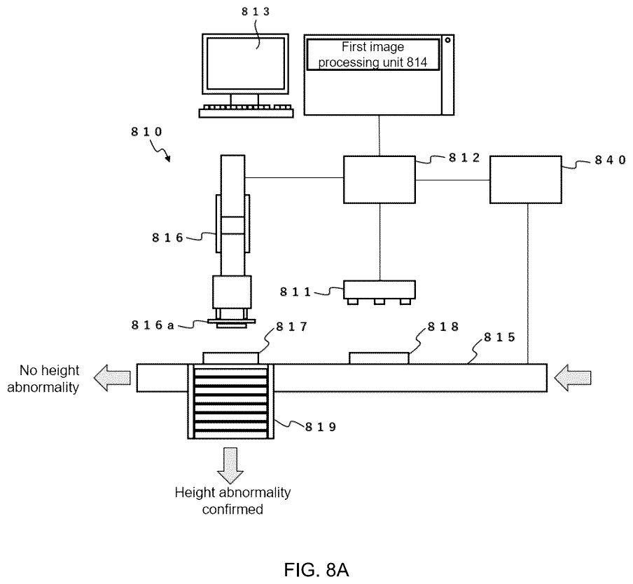

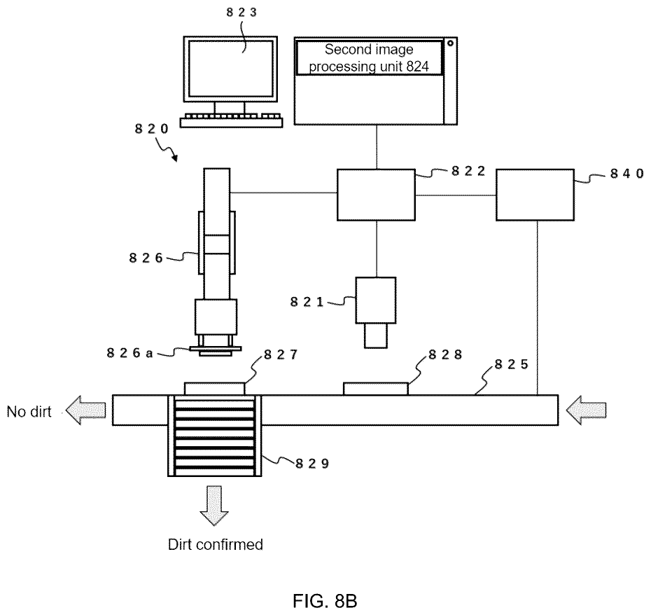

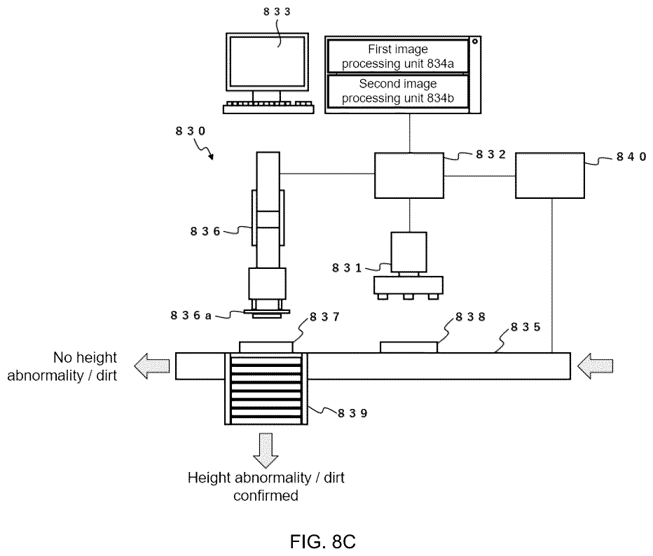

The step A1 and the step B1 can be carried out by an inspection device 810. FIG. 8A is a schematic side view for explaining the configuration of an inspection device 810 according to the first embodiment of the present invention. The inspection device 810 comprises a 3D scanner 811, a first image processing unit 814 capable of performing the step B1 by performing image processing on the first image obtained by the 3D scanner 811, an output unit 813 capable of outputting the results of performing the step B1 by the first image processing unit 814, and an imaging controller 812 capable of controlling the 3D scanner 811.

The output unit 813 may be a display device such as an LCD, an organic EL display, or the like. The function of the first image processing unit 814 can be executed by software installed in a computer such as a personal computer, a mainframe, or a workstation. For example, the software may be provided with the 3D scanner 811 or commercially available image processing software.

The inspection device 810 can be positioned such that the setter 818 on a conveyor 815 can be inspected. In addition, the inspection device 810 may also comprise a robot 816 capable of removing the setter 818 from the conveyor 815. An industrial robot such as a six-axis vertical articulated robot or a three-axis vertical articulated robot can be used as the robot 816. The robot 816 can have a hand 816a capable of gripping or adsorbing the setter 817. The robot 816 can be controlled by a transport controller 840.

A procedure for carrying out the step A1 and the step B1 using the inspection device 810 will be described. When the setter 818 on the conveyor 815 is transported to an inspection position by the 3D scanner 811, the setter 818 temporarily stops. The conveyor 815 can be controlled by a transport controller 840. Whether the setter 818 has been transported to the inspection position can be determined by using, for example, a sensor (not shown). In one embodiment, when the sensor confirms that the setter 818 is in the inspection position, the confirmation result is transmitted to the imaging controller 812, which automatically controls the 3D scanner 811, and the 3D scanner 811 then captures an image of the placement surface of the setter 818. Alternatively, when the sensor confirms that the setter 818 is in the inspection position, the 3D scanner 811 may image the placement surface of the setter 818 by human operating the imaging controller 812. When the 3D scanner 811 images the placement surface of the setter 818, the imaging controller 812 obtains an image (first image) having coordinate information and height information corresponding to the placement surface of the setter (step A1). The first image can be output from the output unit 813.

Next, the first image processing unit 814 that has received the first image from the imaging controller 812 judges the presence or absence of local height abnormality on the placement surface of the setter 818 based on the coordinate information and the height information of the pixels that constitute the first image of the placement surface of the setter 818 (step B1). The judgment can be made with reference to predetermined criteria.

As the result of the inspection, if it is determined that there is no local height abnormality, the transport controller 840 starts the conveyor 815 again and sends the setter 818 to the next process. On the other hand, if it is determined that there is a local height abnormality, the transport controller 840 starts the conveyor 815 again, transports the setter 818 to a specified position, then stops it, and controls the robot 816 to remove the setter 817 from the conveyor 815. For example, the robot 816 can adsorb a setter 817 that is determined to have a local height abnormality and transport it to a slope 819. When the adsorption of the setter 817 is released on the slope 819, the setter 817 slides down the slope 819 and is collected in a specified collection box (not shown). The transport controller 840 may be operated by a human, or a mechanism may be established to automatically transmit the inspection results to the transport controller 840 so that the transport controller 840 automatically controls the conveyor 815 and the robot 816.

### 3-2. Second Embodiment

The method for inspecting a setter according to the second embodiment comprises:
a step A2 of imaging the placement surface of the setter using a camera to obtain a second image of the placement surface, wherein each pixel constituting the second image has a coordinate information and a luminance information; and
a step C2 of determining whether or not there is a local dirt on the placement surface based on the coordinate information and the luminance information of each pixel constituting the second image of the placement surface.

In the step A2, a camera is used to capture an image of the placement surface of the setter to be inspected, and a second image of the placement surface is obtained, in which each pixel constituting the image has a coordinate information and a luminance information. There are no particular limitations on the camera as long as it can obtain a second image having the coordinate information and the luminance information of the placement surface of the setter. For example, a digital camera capable of obtaining a two-dimensional image having the coordinate information and the luminance information of the placement surface of the setter can be suitably used. Either a monochrome camera or a color camera may be used, but a color camera is preferred since it can obtain color information in addition to luminance information. When a color camera is used, the luminance information may be the luminance value (intensity) of any one of the red (R), green (G), and blue (B) components, or may be a luminance value (intensity) based on all color components (for example, a total value or an average value). However, when determining the presence or absence of reddish-black dirt, since it is easy to obtain an image with contrast in the blue component (B), it is preferable that the second image be an image in which at least the luminance of the blue component (B) is extracted, and it is even more preferable that the second image be an image in which only the luminance of the blue component (B) is extracted. The digital camera preferably has a pixel resolution of 100 μm/pix or less in each of the planar directions (X direction, Y direction), and for example, a digital camera with a pixel resolution of 50 to 80 μm/pix in each of the planar directions (X direction, Y direction) can be used.

By using a camera, it is possible to obtain images containing objective information about the luminance of each local region (each pixel on the image) on the placement surface of the setter, making the inspection more efficient. The second image can be provided, for example, as an image in which coordinate information and luminance information are associated by light and darkness (see FIG. 7). In the image, the dirt on the right side of the placement surface of the setter is visually recognized as a locally low (dark) area of luminance.

In the step C2, the presence or absence of local dirt on the placement surface is determined based on the coordinate information and the luminance information of each pixel constituting the second image on the placement surface. This decision can be made by a human or by software based on predetermined criteria. The coordinate information of each pixel constituting the second image of the placement surface is information about the position of the pixel in the planar direction in the second image. Here, the coordinate information may be expressed as a set of numbers for specifying the position of a pixel in the second image, or may be expressed by the position of a pixel in the second image. When imaging the placement surface of the setter, it is desirable to image the surface from a direction as perpendicular as possible to the placement surface of the setter. Furthermore, in order to deal with cases in which the imaging direction is tilted, the aforementioned tilt correction may be performed.

The criteria for determining whether or not there is a local dirt on the placement surface can be set by collecting, for a large number of setters, the coordinate information and the luminance information of the placement surface of the setters, and a data set regarding the presence or absence of discoloration of the honeycomb structure manufactured using the setters, and deriving the causal relationship between these two. As a method for determining whether or not a honeycomb structure has discolored, for example, there is a method in which discoloration is determined to have occurred when discoloration (color transfer from the setter) of a specified area is visually observed on the end surface of the honeycomb structure that was in contact with the setter during firing, and discoloration is determined to have not occurred when such discoloration of a specified area is not visually observed.

The criteria for determining whether or not there is a local dirt on the placement surface are set in consideration of the following (a) to (d).
(a) Minimize the percentage of cases where the setter was judged to have no dirt but the honeycomb structure was discolored (setter OK/honeycomb NG).
(b) Minimize the percentage of cases where the setter was judged to have dirt but the honeycomb structure was not discolored (setter NG/honeycomb OK).
(c) Maximize the percentage of cases where the setter was judged to have no dirt and the honeycomb structure was also not discolored (setter OK/honeycomb OK).
(d) Maximize the percentage of cases where the setter was judged to have dirt and the honeycomb structure was also discolored (setter NG/honeycomb NG).

Among these, the highest priority is given to reducing the percentage of setter OK/honeycomb NG.

The criteria are preferably set such that the percentage of setter OK/honeycomb NG is, for example, 0.30% or less, and more preferably 0.01% or less, with respect to the number of the setters inspected. Furthermore, the criteria are preferably set such that the percentage of setter NG/honeycomb OK is 0.30% or less, and more preferably 0.01% or less, with respect to the number of the setters inspected. However, since the occurrence of discoloration in the honeycomb structure is not only due to the dirt in the setters, it is difficult to reduce the percentage to completely 0%.

Furthermore, the criteria are preferably set such that the percentage of setter OK/honeycomb OK is, for example, 99.90% or more, and more preferably 99.98% or more, with respect to the number of the setters inspected. Furthermore, the criteria are preferably set such that the percentage of setter NG/honeycomb NG is 99.90% or more, and more preferably 99.98% or more, with respect to the number of the setters inspected. However, since whether or not discoloration occurs in the honeycomb structure is not only due to the dirt in the setter, it is difficult to increase the percentage to 100%.

The causal relationship between these two may be learned by machine learning using the coordinate information and luminance information of the placement surface of the setter, and the presence or absence of discoloration of a honeycomb structure manufactured using the setter, as training data. Prediction accuracy is improved if all honeycomb formed bodies to be fired for machine learning are those that are to be given the same product number (that is, honeycomb formed bodies with the same design specifications). For the machine learning, known learning models such as a neural network, a support vector machine, or the like. Deep learning may be used when training the neural network.

In one embodiment, the step C2 is carried out based on whether or not a region satisfying a predetermined luminance abnormality condition is present in the second image of the placement surface and spreads so as to satisfy a predetermined size condition. The predetermined condition for the luminance abnormality may be, for example, a condition regarding a difference or a ratio with respect to an average luminance of the placement surface.

Furthermore, the predetermined size condition may be a condition regarding the area or diameter (equivalent circle diameter or the like) of a continuous region that satisfies a condition regarding the difference or ratio with respect to the average luminance of the placement surface. According to the inventor's experiments, for example, assuming the average luminance of the support surface is 100%, it is possible to obtain high inspection accuracy by determining that a local dirt exists on the placement surface when there is one or more continuous regions having a luminance smaller than X % (selected from 30≤X≤70) with an area of Y mm² (selected from 0.2≤Y≤1.5) or more.

Therefore, in one embodiment, the step C2 comprises calculating the difference or ratio between an average luminance calculated based on luminance information possessed by all pixels constituting the second image of the placement surface and the luminance possessed by each pixel constituting the second image of the placement surface.

The step A2 and the step C2 can be carried out by an inspection device 820. FIG. 8B is a schematic side view for explaining the configuration of an inspection device 820 according to the second embodiment of the present invention. The inspection device 820 comprises a camera 821, a second image processing unit 824 capable of carrying out the step C2 by image processing a second image obtained by the camera 821, an output unit 823 capable of outputting the results of carrying out the step C2 by the second image processing unit 824, and an imaging controller 822 capable of controlling the camera 821.

The output unit 823 may be a display device such as an LCD, an organic EL display, or the like. The function of the first image processing unit 824 can be executed by software installed in a computer such as a personal computer, a mainframe, or a workstation. For example, the software may be provided with the camera 821 or commercially available image processing software.

The inspection device 820 can be positioned such that the setter 828 on a conveyor 825 can be inspected. In addition, the inspection device 820 may also comprise a robot 826 capable of removing the setter 828 from the conveyor 825. An industrial robot such as a six-axis vertical articulated robot or a three-axis vertical articulated robot can be used as the robot 826. The robot 826 can have a hand 826a capable of gripping or adsorbing the setter 827. The robot 826 can be controlled by a transport controller 840.

The procedure for carrying out the step A2 and the step C2 using the inspection device 820 will be described. When the setter 828 on the conveyor 825 is transported to an inspection position by the camera 821, the setter 828 temporarily stops. The conveyor 825 can be controlled by a transport controller 840. Whether the setter 828 has been transported to the inspection position can be determined by using, for example, a sensor (not shown). In one embodiment, when the sensor confirms that the setter 828 is in the inspection position, the confirmation result is transmitted to the imaging controller 822, which automatically controls the camera 821, and the camera 821 then captures an image of the placement surface of the setter 828. Alternatively, when the sensor confirms that the setter 828 is in the inspection position, the camera 821 may image the placement surface of the setter 828 by human operating the imaging controller 822. When the camera 821 images the placement surface of the setter 828, the imaging controller 822 captures an image (second image) having coordinate information and luminance information corresponding to the placement surface of the setter (step A2). The second image can be output from the output unit 823.

Next, the second image processing unit 824 that has received the second image from the imaging controller 822 judges the presence or absence of local dirt on the placement surface of the setter 828 based on the coordinate information and the luminance information of the pixels that constitute the second image of the placement surface of the setter 828 (step C2). The judgment can be made with reference to predetermined criteria.

As the result of the inspection, if it is determined that there is no local dirt, the transport controller 840 starts the conveyor 825 again and sends the setter 828 to the next process. On the other hand, if it is determined that there is a local dirt, the transport controller 840 starts the conveyor 825 again, transports the setter 828 to a specified position, then stops it, and controls the robot 826 to remove the setter 827 from the conveyor 825. For example, the robot 826 can adsorb a setter 827 that is determined to have a local dirt and transport it to a slope 829. When the adsorption of the setter 827 is released on the slope 829, the setter 827 slides down the slope 829 and is collected in a specified collection box (not shown). The transport controller 840 may be operated by a human, or a mechanism may be established to automatically transmit the inspection results to the transport controller 840 so that the transport controller 840 automatically controls the conveyor 825 and the robot 826.

### 3-3. Third Embodiment

The method for inspecting a setter according to the third embodiment comprises:
a step A3 of imaging the placement surface of the setter using a camera-type 3D scanner to obtain a first image of the placement surface, wherein each pixel constituting the first image has a coordinate information and a height information, and a second image of the placement surface, wherein each pixel constituting the second image has a coordinate information and a luminance information;
a step B3 of determining whether or not there is a local height abnormality on the placement surface based on the coordinate information and the height information of each pixel constituting the first image of the placement surface; and
a step C3 of determining whether or not there is a local dirt on the placement surface based on the coordinate information and the luminance information of each pixel constituting the second image of the placement surface.

In the step A3, the placement surface of the setter is imaged using a camera-type 3D scanner to obtain a first image of the placement surface, wherein each pixel constituting the first image has a coordinate information and a height information, and a second image of the placement surface, wherein each pixel constituting the second image has a coordinate information and a luminance information. The camera-type 3D scanner is a device that combines the functions of the 3D scanner and a camera described above, and can simultaneously obtain coordinate information, height information, and luminance information of the placement surface of a setter. Therefore, there is an advantage that it is possible to quickly inspect both the presence or absence of height abnormality and the presence or absence of dirt in the setter. When using a camera-type 3D scanner, it is also possible to perform various processes, noise removal, tilt correction, etc. of the 3D scanner described in the first embodiment.

When capturing an image using a camera-type 3D scanner, noise may occur due to the projection of the grid pattern light. Therefore, in order to remove noise, it is preferable to remove noise by taking the difference in height information for each pixel between an image obtained by imaging a jig (master jig) that mimics a normal placement surface of the setter with a 3D scanner and the first image. The difference may be regarded as height information for each pixel in the first image. In addition, when imaging the placement surface of the setter, it is desirable to image the placement surface of the setter from a direction as perpendicular as possible to the placement surface of the setter. Furthermore, in order to deal with cases where the imaging direction is tilted, it is preferable to calculate the surface tilt based on height information for each pixel in the first image and perform processing to make the tilt zero by tilt correction.

By using a camera-type 3D scanner, it is possible to obtain images containing objective information about the height of each local region (each pixel on the image) that constitutes up the placement surface of the setter, making inspections more efficient. The first image can be provided, for example, as a heat map in which coordinate information and height information are associated (see FIG. 6). In the heat map, height differences are displayed by color, making it easy to visually identify local height abnormality. In the left image, a locally high height region is visible on the left side of the placement surface of the setter. In the right image, a locally high height region is visible on the bottom right of the setter.

Further, by using a camera-type 3D scanner, it is possible to obtain images containing objective information about the luminance of each local region (each pixel on the image) on the placement surface of the setter, making the inspection more efficient. The second image can be provided, for example, as an image in which coordinate information and luminance information are associated by light and darkness (see FIG. 7). In the image, the dirt on the right side of the placement surface of the setter is visually recognized as a locally low (dark) region of luminance.

In the step B3, the presence or absence of a local height abnormality on the placement surface is determined based on the coordinate information and the height information of each pixel constituting the first image of the placement surface. The details of the step B3 are as described in the step B1, so a duplicated description will be omitted.

In the step C3, the presence or absence of local dirt on the placement surface is determined based on the coordinate information and the luminance information of each pixel constituting the second image on the placement surface. The details of the step C3 are as described in the step C2, so a duplicated description will be omitted.

The step A3, the step B3, and the step C3 can be carried out by an inspection device 830. FIG. 8C is a schematic side view illustrating the configuration of an inspection device 830 according to the third embodiment of the present invention. The inspection device 830 comprises a camera-type 3D scanner 831, a first image processing unit 834a capable of carrying out the step B3 by image processing the first image obtained by the camera-type 3D scanner 831, a second image processing unit 834b capable of carrying out the step C3 by image processing the second image obtained by the camera-type 3D scanner 831, an output unit 833 capable of outputting the result of carrying out the step B3 by the first image processing unit 834a and the result of carrying out the step C3 by the second image processing unit, and an imaging controller 832 capable of controlling the camera-type 3D scanner 831.

The output unit 833 may be a display device such as an LCD, an organic EL display, or the like. The function of the first image processing unit 834a and the second image processing unit 834b can be executed by software installed in a computer such as a personal computer, a mainframe, or a workstation. For example, the software may be provided with the camera-type 3D scanner 831 or commercially available image processing software.

The inspection device 830 can be positioned such that the setter 838 on a conveyor 835 can be inspected. In addition, the inspection device 830 may also comprise a robot 836 capable of removing the setter 838 from the conveyor 835. An industrial robot such as a six-axis vertical articulated robot or a three-axis vertical articulated robot can be used as the robot 836. The robot 836 can have a hand 836a capable of gripping or adsorbing the setter 837. The robot 836 can be controlled by a transport controller 840.

The procedure for carrying out the step A3, the step B3, and the step C3 using the inspection device 830 will be described. When the setter 838 on the conveyor 835 is transported to an inspection position by the camera-type 3D scanner 831, the setter 838 temporarily stops. The conveyor 835 can be controlled by a transport controller 840. Whether the setter 838 has been transported to the inspection position can be determined by using, for example, a sensor (not shown). In one embodiment, when the sensor confirms that the setter 838 is in the inspection position, the confirmation result is transmitted to the imaging controller 832, which automatically controls the camera-type 3D scanner 831, and the camera-type 3D scanner 831 then captures an image of the placement surface of the setter 838. Alternatively, when the sensor confirms that the setter 838 is in the inspection position, the camera-type 3D scanner 831 may image the placement surface of the setter 838 by human operating the imaging controller 832. When the camera-type 3D scanner 831 captures an image of the placement surface of the setter 838, a first image and a second image are obtained by the imaging controller 832 (step A3). The first image and the second image can be output from the output unit 833.

Next, the first image processing unit 834a that has received the first image from the imaging controller 832 judges the presence or absence of local height abnormality on the placement surface of the setter 838 based on the coordinate information and the height information of the pixels that constitute the first image of the placement surface of the setter 838 (step B3). The judgment in the step B3 can be made with reference to predetermined criteria. Further, the second image processing unit 834b that has received the second image from the imaging controller 832 judges the presence or absence of local dirt on the placement surface of the setter 838 based on the coordinate information and the luminance information of the pixels that constitute the second image of the placement surface of the setter 838 (step C3). The judgment in the step C3 also can be made with reference to predetermined criteria.

As the result of the inspection, if it is determined that there is neither a local height abnormality nor a local dirt, the transport controller 840 starts the conveyor 835 again and sends the setter 838 to the next process. On the other hand, if it is determined that there is a local height abnormality and/or there is a local dirt, the transport controller 840 starts the conveyor 835 again, transports the setter 838 to a specified position, then stops it, and controls the robot 836 to remove the setter 837 from the conveyor 835. For example, the robot 836 can adsorb a setter 837 that is determined to have a local height abnormality and/or a local dirt and transport it to a slope 839. When the adsorption of the setter 837 is released on the slope 839, the setter 837 slides down the slope 839 and is collected in a specified collection box (not shown). The transport controller 840 may be operated by a human, or a mechanism may be established to automatically transmit the inspection results to the transport controller 840 so that the transport controller 840 automatically controls the conveyor 835 and the robot 836.

### <4. Method for Manufacturing a Honeycomb Structure>

According to one embodiment of the present invention, there is provided a method for manufacturing a honeycomb structure using the above-mentioned methods for inspecting a setter. In this manufacturing method, since setters that have passed the inspection in advance are used, the yield of honeycomb structures is improved.

In one embodiment, the method for manufacturing a honeycomb structure comprises:
a step of placing a setter that has passed the inspection as a result of carrying out the inspection method on a shelf board;
a step of preparing a honeycomb formed body having an outer peripheral side wall and partition walls disposed on an inner peripheral side of the outer peripheral side wall, the partition walls partitioning a plurality of cells forming a flow path from a first end surface to a second end surface; and
a step of placing the honeycomb formed body on the setter on the shelf board such that the first end surface or the second end surface is in contact with the placement surface of the setter, and firing the honeycomb formed body.

In the inspection method according to the first embodiment, a setter that has passed the inspection method refers to a setter that has been determined to have no local height abnormality. In the inspection method according to the second embodiment, a setter that has passed the inspection method refers to a setter that has been determined to have no local dirt. In the inspection method according to the third embodiment, a setter that has passed the inspection method refers to a setter that has been determined to have no local height abnormality and no local dirt.

The honeycomb formed body can be prepared, for example, by kneading a raw material composition containing a ceramic raw material, a dispersion medium, a pore-forming material, and a binder to form a green body, and then extrusion molding the green body, followed by a drying process. Sealing portions may be formed on both end surfaces of the honeycomb formed body.

The firing step depends on the material composition of the honeycomb formed body, but can be carried out, for example, by heating a calcined body to 1350 to 1600° C. and holding it for 3 to 10 hours. The degreasing step may be carried out before the firing step, or the firing step may be carried out consecutively after the degreasing step. The combustion temperature of the binder is about 200° C., and the combustion temperature of the pore forming material is about 300 to 1000° C. Therefore, the degreasing step may be carried out by heating the honeycomb formed body to a temperature in the range of about 200 to 1000° C. The heating time is not particularly limited, but is usually about 10 to 100 hours.

### EXAMPLES

### (1. Data Collection)

A cordierite raw material, a pore forming material, a dispersion medium, an organic binder, and a dispersant were mixed and kneaded in a predetermined mixing ratio to prepare a green body. This green body was charged into an extrusion molding machine and extrusion molded through a die of a predesigned shape to obtain a cylindrical honeycomb formed body. Separately, by a pressing process and a firing process, a mullite-based setter (area of the placement surface=6200 mm²) was prepared. The obtained honeycomb formed body was subjected to dielectric drying and hot gas drying, and then both end surfaces were cut to a predetermined size. Next, the obtained honeycomb formed body was placed on a shelf board with the setter interposed therebetween, and then loaded into a firing furnace. After being degreased in the air atmosphere, it was further fired in the air at 1420° C. for 5 hours. In this way, a plurality of honeycomb structures was obtained.

This honeycomb structure had the following design specifications:
Overall shape: Cylindrical with diameter 118 mm×height 91 mm
Cell shape in cross section perpendicular to the cell flow direction: Square
Cell density (number of cells per unit cross-sectional area): 93 cells/cm²
Partition wall thickness: 76 μm (nominal value based on the specifications of the die)
Material: Cordierite

The end surface of the obtained honeycomb structure, which had been in contact with the placement surface of the setter, was visually inspected to check for deformation or cracks in the partition walls, as well as for discoloration (color transfer) with an area of 3.14 mm² (φ2.0 mm) or more per location. Further, by using a camera-type 3D scanner, a first image having coordinate information and height information and a second image having coordinate information and luminance information of the placement surface of the setter used to fire each honeycomb structure were recorded. In addition, the first image was subjected to the above-mentioned noise removal and tilt correction using the image processing software “HALCON” from LINX Corporation installed on a PC. For the second image, noise was removed using the image processing software “HALCON” from LINX Corporation installed on the PC. As a result, the properties of the placement surfaces of more than 170,000 setters were recorded in association with the properties of the end surfaces of the honeycomb structures, and the causal relationship was investigated using the image processing software “HALCON” from LINX Corporation.

The camera-type 3D scanner was constructed using a Keyence Corporation camera: VJ-H500CX, imaging controller: VJ-3000, and pattern projection lighting: CA-DP12X. In addition, this camera-type 3D scanner employed a pattern projection method and the following lighting conditions were used.
Dimming value: 80/100
Exposure time: 7500 usec
Number of light projections: 8
X-direction pixel resolution: 75 μm/pix.
Y-direction pixel resolution: 75 μm/pix
Z-direction pixel resolution: 5 μm/1 luminance value

### (2. Relationship Between Local Height Abnormality on the Placement Surface of the Setter and Deformation or Cracks on the End Surface of the Honeycomb Structure)

Based on the data obtained above, the relationship between the local height abnormality on the placement surface of the setter and the presence or absence of deformation or cracks on the end surface of the honeycomb structure was analyzed. As a result, it was found that the following high inspection accuracy could be obtained by determining that there is a local height abnormality on the placement surface of the setter (setter NG) when at least one of the following conditions is met (others were determined as no abnormality (setter OK)): there is one or more continuous regions with an area of 0.258 mm² or more that are higher by more than 0.15 mm relative to the average height of the placement surface of the setter; the total area of dispersed regions that are higher by more than 0.15 mm relative to the average height of the placement surface of the setter is 0.258 mm² or more.
(a) The percentage of cases where the setter was judged to have no abnormality but the honeycomb structure had at least one of deformation or cracks (setter OK/honeycomb NG)=0.02%.
(b) The percentage of cases where the setter was judged to have an abnormality but the honeycomb structure did not have any deformation or cracks (setter NG/honeycomb OK)=0.03%.
(c) The percentage of cases where the setter was judged to have no abnormality and the honeycomb structure did not also have any deformation or cracks (setter OK/honeycomb OK)=99.95%.
(d) The percentage of cases where the setter was judged to have an abnormality and the honeycomb structure also had at least one of deformation or cracks (setter NG/honeycomb NG)=99.94%.

### (3. Relationship Between Local Dirt on the Placement Surface of the Setter and Discoloration on the End Surface of the Honeycomb Structure)

Based on the data obtained above, the relationship between the local dirt on the placement surface of the setter and the discoloration on the end surface of the honeycomb structure was analyzed. As a result, it was found that the following high inspection accuracy could be obtained by determining that there is a local dirt on the placement surface of the setter (setter NG), when there is one or more continuous regions with an area of 1.0 mm² or more where the luminance (intensity) of the blue component (B) is less than 60%, assuming the average luminance (intensity) of the blue component (B) on the placement surface is 100% (others were determined to have no dirt (setter OK)).
(a) The percentage of cases where the setter was judged to have no dirt but the honeycomb structure was discolored (setter OK/honeycomb NG)=0.01%.
(b) The percentage of cases where the setter was judged to have dirt but the honeycomb structure was not discolored (setter NG/honeycomb OK)=0.01%.
(c) The percentage of cases where the setter was judged to have no dirt and the honeycomb structure was also not discolored (setter OK/honeycomb OK)=99.98%.
(d) The percentage of cases where the setter was judged to have dirt and the honeycomb structure was also discolored (setter NG/honeycomb NG)=99.99%.

From the above results, it can be seen that there is a high correlation between local height abnormality on the placement surface of the setter and the occurrence of deformation or cracks on the partition walls on the end surface of the manufactured honeycomb structure. Further, it can also be seen that there is a high correlation between the local dirt on the placement surface of the setter and the discoloration on the end surface of the manufactured honeycomb structure. Therefore, by utilizing statistical data and setting appropriate criteria, it will be possible to inspect setters with a high accuracy.

### DESCRIPTION OF REFERENCE NUMERALS

1: Setter
2: Lower surface
3: Placement surface
4: Side surface
7: Groove
20: Honeycomb formed body
21: Shelf board
22: End surface
100: Honeycomb structure
102: Outer peripheral side wall
104: First end surface
106: Second end surface
108: Cell
112: Partition wall
200: Honeycomb structure
202: Outer peripheral side wall
204: First end surface
206: Second end surface
208a: First cell
208b: Second cell
209: Sealing portion
212: Partition wall
810: Inspection device
811: 3D scanner
812: Imaging controller
813: Output unit
814: First image processing unit
815: Conveyor
816: Robot
816a: Hand
817: Setter
818: Setter
819: Slope
820: Inspection device
821: Camera
822: Imaging controller
823: Output unit
824: Second image processing unit
825: Conveyor
826: Robot
826a: Hand
827: Setter
828: Setter
829: Slope
830: Inspection device
831: Camera-type 3D scanner
832: Imaging controller
833: Output unit
834a: First image processing unit
834b: Second image processing unit
835: Conveyor
836: Robot
836a: Hand
837: Setter
838: Setter
839: Slope
840: Transport controller

1. A method for inspecting a setter, which is disposed between a shelf board and a honeycomb formed body when the honeycomb formed body is fired, the setter comprising a placement surface for placing the honeycomb formed body, the method comprising:
a step A1 of imaging the placement surface using a 3D scanner to obtain a first image of the placement surface, wherein each pixel constituting the first image has a coordinate information and a height information; and
a step B1 of determining whether or not there is a local height abnormality on the placement surface based on the coordinate information and the height information of each pixel constituting the first image of the placement surface.

2. The method according to claim 1, wherein the step B1 is carried out based on whether or not a region satisfying a predetermined height abnormality condition is present and extends so as to satisfy a predetermined size condition in the first image of the placement surface.

3. The method according to claim 1, wherein the step B1 comprises calculating a difference or ratio between an average height calculated based on the height information possessed by all pixels constituting the first image of the placement surface and a height possessed by each pixel constituting the first image of the placement surface.

4. The method according to claim 1, wherein the first image is provided as a heat map in which the coordinate information and the height information are associated with each other.

5. The method according to claim 1, wherein an inspection device carries out the step A1 and the step B1, the inspection device comprising:
the 3D scanner;
a first image processing unit capable of carrying out the step B1 by image processing the first image obtained by the 3D scanner; and
an output unit capable of outputting a result of carrying out the step B1 by the first image processing unit.

6. The method according to claim 5, wherein the inspection device is disposed at a position where the inspection device can inspect the setter on a conveyor,
wherein the inspection device comprises a robot capable of removing the setter from the conveyor and a transport controller capable of controlling the robot, and
when the inspection device performs the method for inspecting the setter on the conveyor and determines that there is the local height abnormality, the inspection device controls the robot to remove the setter from the conveyor.

7. A method for manufacturing a honeycomb structure, comprising:
a step of carrying out the method according to claim 1;
a step of placing the setter that is determined to have no local height abnormality as a result of carrying out the method on the shelf board;
a step of preparing a honeycomb formed body having an outer peripheral side wall and partition walls disposed on an inner peripheral side of the outer peripheral side wall, the partition walls partitioning a plurality of cells forming a flow path from a first end surface to a second end surface; and
a step of placing the honeycomb formed body on the setter on the shelf board such that the first end surface or the second end surface is in contact with the placement surface of the setter, and firing the honeycomb formed body.

8. A method for inspecting a setter, which is disposed between a shelf board and a honeycomb formed body when the honeycomb formed body is fired, the setter comprising a placement surface for placing the honeycomb formed body, the method comprising:
a step A2 of imaging the placement surface using a camera to obtain a second image of the placement surface, wherein each pixel constituting the second image has a coordinate information and a luminance information; and
a step C2 of determining whether or not there is a local dirt on the placement surface based on the coordinate information and the luminance information of each pixel constituting the second image of the placement surface.

9. The method according to claim 8, wherein the step C2 is carried out based on whether or not a region satisfying a predetermined luminance abnormality condition is present and spreads so as to satisfy a predetermined size condition in the second image of the placement surface.

10. The method according to claim 8, wherein the step C2 comprises calculating a difference or ratio between an average luminance calculated based on the luminance information possessed by all pixels constituting the second image of the placement surface and a luminance possessed by each pixel constituting the second image of the placement surface.

11. The method according to claim 8, wherein an inspection device carries out the step A2 and the step C2, the inspection device comprising:
the camera;
a second image processing unit capable of carrying out the step C2 by image processing the second image obtained by the camera; and
an output unit capable of outputting a result of carrying out the step C2 by the second image processing unit.

12. The method according to claim 11, wherein the inspection device is disposed at a position where the inspection device can inspect the setter on a conveyor,
wherein the inspection device comprises a robot capable of removing the setter from the conveyor and a transport controller capable of controlling the robot, and
when the inspection device performs the method for inspecting the setter on the conveyor and determines that there is the local dirt, the inspection device controls the robot to remove the setter from the conveyor.

13. A method for manufacturing a honeycomb structure, comprising:
a step of carrying out the inspection method according to claim 8;
a step of placing the setter that is determined to have no local dirt as a result of carrying out the inspection method on the shelf board;
a step of preparing a honeycomb formed body having an outer peripheral side wall and partition walls disposed on an inner peripheral side of the outer peripheral side wall, the partition walls partitioning a plurality of cells forming a flow path from a first end surface to a second end surface; and
a step of placing the honeycomb formed body on the setter on the shelf board such that the first end surface or the second end surface is in contact with the placement surface of the setter, and firing the honeycomb formed body.

14. A method for inspecting a setter, which is disposed between a shelf board and a honeycomb formed body when the honeycomb formed body is fired, the setter comprising a placement surface for placing the honeycomb formed body, the method comprising:
a step A3 of imaging the placement surface using a camera-type 3D scanner to obtain a first image of the placement surface, wherein each pixel constituting the first image has a coordinate information and a height information, and a second image of the placement surface, wherein each pixel constituting the second image has a coordinate information and a luminance information;
a step B3 of determining whether or not there is a local height abnormality on the placement surface based on the coordinate information and the height information of each pixel constituting the first image of the placement surface; and
a step C3 of determining whether or not there is a local dirt on the placement surface based on the coordinate information and the luminance information of each pixel constituting the second image of the placement surface.

15. The method according to claim 14, wherein the step B3 is carried out based on whether or not a region satisfying a predetermined height abnormality condition is present and spreads so as to satisfy a predetermined size condition in the first image of the placement surface.

16. The method according to claim 14, wherein the step B3 comprises calculating a difference or ratio between an average height calculated based on the height information possessed by all pixels constituting the first image of the placement surface and a height possessed by each pixel constituting the first image of the placement surface.

17. The method according to claim 14, wherein the first image is provided as a heat map in which the coordinate information and the height information are associated with each other.

18. The method according to claim 14, wherein the step C3 is carried out based on whether or not a region satisfying a predetermined luminance abnormality condition is present and spreads so as to satisfy a predetermined size condition in the second image of the placement surface.

19. The method according to claim 14, wherein the step C3 comprises calculating a difference or ratio between an average luminance calculated based on the luminance information possessed by all pixels constituting the second image of the placement surface and a luminance possessed by each pixel constituting the second image of the placement surface.

20. The method according to claim 14, wherein an inspection device carries out the step A3, the step B3, and the step C3, the inspection device comprising:
the camera-type 3D scanner;
a first image processing unit capable of carrying out the step B3 by image processing the first image obtained by the camera-type 3D scanner;
a second image processing unit capable of carrying out the step C3 by image processing the second image obtained by the camera-type 3D scanner; and
an output unit capable of outputting a result of carrying out the step B3 by the first image processing unit and a result of carrying out the step C3 by the second image processing unit.

21. The method according to claim 20, wherein the inspection device is disposed at a position where the inspection device can inspect the setter on a conveyor,
wherein the inspection device comprises a robot capable of removing the setter from the conveyor and a transport controller capable of controlling the robot, and
when the inspection device performs the method for inspecting the setter on the conveyor, and determines that there is the local height abnormality and/or determines that there is the local dirt, the inspection device controls the robot to remove the setter from the conveyor.

22. A method for manufacturing a honeycomb structure, comprising:
a step of carrying out the method according to claim 14;
a step of placing the setter that is determined to have no height abnormality and have no local dirt as a result of carrying out the method on the shelf board;
a step of preparing a honeycomb formed body having an outer peripheral side wall and partition walls disposed on an inner peripheral side of the outer peripheral side wall, the partition walls partitioning a plurality of cells forming a flow path from a first end surface to a second end surface; and
a step of placing the honeycomb formed body on the setter on the shelf board such that the first end surface or the second end surface is in contact with the placement surface of the setter, and firing the honeycomb formed body.
